(19) United States
(12) Patent Application Publication
(10) Pub. No.: US 2025/0100848 A1
(43) Pub. Date: Mar. 27, 2025

(54) ARRANGEMENT AND A METHOD FOR AUDITING CAR GUIDE RAIL STRAIGHTNESS

(71) Applicant: Kone Corporation, Helsinki (FI)

(72) Inventors: Giovanni HAWKINS, Helsinki (FI); Sami JANHUNEN, Helsinki (FI); Petteri DAMMERT, Helsinki (FI)

(73) Assignee: Kone Corporation, Helsinki (FI)

(21) Appl. No.: 18/973,762

(22) Filed: Dec. 9, 2024

Related U.S. Application Data
(63) Continuation of application No. PCT/EP2022/070683, filed on Jul. 22, 2022.

(51) Int. Cl. B66B 5/00; G01B 5/20

(52) U.S. Cl. CPC B66B 5/0025; G01B 5/20

(57) ABSTRACT

The invention relates to an arrangement for auditing straightness of a car guide rail, the arrangement comprising: a car guide rail mounted in an elevator shaft; an elevator car connected to the car guide rail via a guide member, said guide member, in a straightness auditing mode being adapted so that the horizontal distance between the elevator car and the car guide rail to be audited is constant; a plumb line stabilized in the elevator shaft adjacent to the car guide rail; an indicator detachably attached to the elevator car, in vicinity of the plumb line; at least one visual recording device detachably attached to the elevator car, facing the plumb line and the indicator, for recording a displacement of the indicator relative to the plumb line; and a memory for storing recorded relative displacement. The invention also relates to a method for auditing straightness of a car guide rail.

### CROSS-REFERENCE TO RELATED APPLICATION

This application is a continuation of PCT International Application No. PCT/EP2022/070683 which has an International filing date of Jul. 22, 2022, the entire contents of which are incorporated herein by reference.

### FIELD OF THE INVENTION

The invention relates to an arrangement and a method for auditing car guide rail straightness.

Such an arrangement and a method for auditing car guide rail straightness is employed during installation of an elevator or during maintenance to ensure that straightness of the car guide rails of the elevator is within desired range.

### BACKGROUND OF THE INVENTION

An elevator may comprise a car, a shaft, hoisting machinery, ropes, and a counterweight. A separate or an integrated car frame may surround the car.

The hoisting machinery may be positioned in the shaft. The hoisting machinery may comprise a drive, an electric motor, a traction sheave, and a machinery brake. The hoisting machinery may move the car upwards and downwards in the shaft. The machinery brake may stop the rotation of the traction sheave and thereby the movement of the elevator car.

The car frame may be connected by the ropes via the traction sheave to the counterweight. The car frame may further be supported with guide members at guide rails extending in the vertical direction in the shaft. The guide rails may be attached with fastening brackets to the side wall structures in the shaft. The guide members keep the car in position in the horizontal plane when the car moves upwards and downwards in the shaft. The counterweight may be supported in a corresponding way on guide rails that are attached to the wall structure of the shaft.

The car may transport people and/or goods between the landings in the building. The wall structure of the shaft may be formed of solid walls or of an open beam structure or of any combination of these.

Vertical straightness of the elevator car guide rails is a crucial feature for ride comfort of the elevator, wear of components, and energy consumption of the elevator. Also, elevator car guide rails are used as a reference for positioning other important elevator components, such as counterweight rails and landing doors. The correct alignment of the elevator car guide rails is therefore critical, and if not corrected early in the installation can cause misalignments of the associated components causing malfunctions and other issues, the root-cause of which may be difficult to identify afterwards.

Conventionally, in most basic elevator installations and maintenance operations, straightness of the car guide rails is audited by hand, which in a dark cold shaft is very time-consuming process and prone to inaccuracies. In practice, the technicians installing or maintaining the car guide rails compare the run of the car guide rails with respect to plumb lines or lasers by eye and/or assisted with a tape measure. The exact alignment is thus dependent on the experience and skill of the technician performing the installation or maintenance. As the visibility in the shaft is often poor, it is difficult for the technician to read the measurements and/or auditing tools in the elevator shaft, making repetitive accurate work in the shaft challenging. This conventional method is also prone to external factors, such as wind blowing in the elevator shaft, or the technician accidentally hitting the plumb lines during auditing, thus making it difficult to get correct readings. All this is time consuming, and if done poorly, a laborious re-work is required. Also, the conventional method often fails to produce exact guide rail auditing results, resulting in the results often not being properly recorded or documented for further analysing.

Also known are separate sensor arrangements intended for high accuracy applications such as high-rise buildings having elevator shaft heights of more than 50 meters. The problem with such systems is that they require expensive special equipment, which may be time consuming to set up, raising the costs of the installation and/or maintenance. Therefore, it is not cost-efficient to utilize such arrangements in elevators installed in high volumes in low-rise or mid-rise buildings.

Therefore, there is a clear need for an improved and cost-efficient arrangement and an improved method for auditing straightness of elevator car guide rails.

### BRIEF DESCRIPTION OF THE INVENTION

An object of the invention is to introduce an improved arrangement and an improved method for auditing car guide rail straightness, which allows the measuring of the straightness of the elevator guide rails in an accurate, easy, and cost-efficient manner. An object is particularly to introduce a solution by which one or more of the above defined problems of prior art and/or problems discussed or implied elsewhere in the description can be solved.

The arrangement for auditing straightness of a car guide rail according to the invention is defined in independent claim 1.

The method for auditing straightness of a car guide rail according to the invention is defined in independent claim 11.

Preferable further details of the arrangement are introduced in the following, which further details can be combined with the arrangement defined in independent claim 1, individually or in any combination.

In a preferred embodiment, the arrangement comprises a ruler scale comprising simple visual markings illustrating if the displacement of the indicator relative to the plumb line is feasible or unfeasible.

In a preferred embodiment, the arrangement comprises a ruler scale comprising more detailed visual markings configured to provide numerical values for said relative displacement.

In a preferred embodiment, the ruler scale is virtual.

In a preferred embodiment, the ruler scale is physical.

In a preferred embodiment, the ruler scale is arranged in background of the plumb line and the indicator viewed from the visual recording device.

In a preferred embodiment, the ruler scale is arranged in the indicator.

In a preferred embodiment, the arrangement comprises a magnifier configured to magnify the displacement of the indicator relative to the plumb line, preferably on the ruler scale.

In a preferred embodiment, the magnifier is virtual.

In a preferred embodiment, the magnifier is physical.

In a preferred embodiment, the visual recording device is configured to face the plumb line and the indicator in a first horizontal direction between the car guide rails.

In a preferred embodiment, the visual recording device is configured to face the plumb line and the indicator in a second horizontal direction perpendicular to said first horizontal direction between the car guide rails.

In a preferred embodiment, the visual recording device is configured to be rotatable at least on a horizontal plane defined by the first horizontal direction and the second horizontal direction.

In a preferred embodiment, the arrangement comprises a servomotor for actuating the rotation of the visual recording device.

In a preferred embodiment, the visual recording device is configured to be movable at least in the first horizontal direction between the car guide rails.

In a preferred embodiment, the arrangement comprises a servomotor for actuating the movement of the visual recording device at least in the first horizontal direction between the car guide rails.

In a preferred embodiment, the visual recording device is configured to be rotatable and movable in the horizontal plane defined by the first horizontal direction and the second horizontal direction.

preferred embodiment, the visual recording device is configured to be rotatable and movable in the horizontal plane defined by the first horizontal direction and the second horizontal direction, such that the visual recording device can face the car guide rail to be audited in the first horizontal direction and in the second horizontal direction.

In a preferred embodiment, the visual recording device is configured to be rotatable at least 180 degrees, preferably 360 degrees.

In a preferred embodiment, the visual recording device is also rotatable on a vertical plane perpendicular to the horizontal plane defined by the first horizontal direction and the second horizontal direction.

In a preferred embodiment, the arrangement comprises two visual recording devices facing the indicator and the plumb line substantially perpendicular in relation to each other, preferably in a first horizontal direction between the car guide rails, and in a second horizontal direction perpendicular to said first horizontal direction between the car guide rails.

In a preferred embodiment, the indicator comprises at least one reference marker, preferably two reference markers, such that a first surface of the indicator facing a first horizontal direction between the car guide rails, and a second surface of the indicator facing a second horizontal direction perpendicular to said first horizontal direction between the car guide rails each comprise a reference marker.

In a preferred embodiment, in the straightness auditing mode, suspension of the guide member connected to the car guide rail to be audited is locked.

In a preferred embodiment, suspension of a second guide member is adapted to press the guide member connected to the car guide rail to be audited against the car guide rail, so that the elevator car follows the car guide rail to be audited.

In a preferred embodiment, the visual recording device is a camera.

In a preferred embodiment, the visual recording device is a device comprising a camera.

In a preferred embodiment, the device comprising the camera is a mobile phone.

In a preferred embodiment, the plumb line is fixed at the top of the elevator shaft.

In a preferred embodiment, the plumb line is fixed to the bottom of the elevator shaft.

In a preferred embodiment, the indicator is detachably attached to the elevator car via a fastening element, preferably comprising a magnet or a clamp.

In a preferred embodiment, the visual recording device is detachably attached to the elevator car via a fastening element, preferably comprising a magnet or a clamp.

In a preferred embodiment, the ruler scale is detachably attached to the elevator car via a fastening element, preferably comprising a magnet or a clamp.

In a preferred embodiment, the indicator and the visual recording device are detachably attached to a dust plate of the guide member.

In a preferred embodiment, the guide member comprises a roller guide.

In a preferred embodiment, the guide member comprises a sliding guide.

Preferable further details of the method are introduced in the following, which further details can be combined with the method defined in independent claim 11 individually or in any combination.

In a preferred embodiment, the method comprising after completion of the auditing steps, repositioning the visual recording device such that the visual recording device faces the plumb line and the indicator in a direction perpendicular relative to its initial position, and then repeating the auditing steps.

In a preferred embodiment, the method comprising performing the recording as a continuous recording.

In a preferred embodiment, the method comprising taking pictures at predetermined times.

In a preferred embodiment, the method comprising arranging the visual recording device to face the plumb line and the indicator in a first horizontal direction between the car guide rails.

In a preferred embodiment, the method comprising arranging the visual recording device to face the plumb line and the indicator in a second horizontal direction perpendicular to said first horizontal direction between the car guide rails.

In a preferred embodiment, the method comprising arranging two visual recording devices facing the plumb line and the indicator, the two visual recording devices positioned perpendicular in relation to each other, preferably in a first horizontal direction between the car guide rails, and in a second horizontal direction perpendicular to said first horizontal direction between the car guide rails.

In a preferred embodiment, the method comprising providing the memory as a remote memory, particularly a cloud memory.

In a preferred embodiment, the method comprising providing a ruler scale in background of the plumb line and the indicator viewed from the visual recording device.

In a preferred embodiment, the method comprising providing the ruler scale in the indicator.

In a preferred embodiment, the method comprising providing a magnifier to magnify the displacement of the indicator relative to the plumb line.

In a preferred embodiment, the method comprising providing a magnifier to magnify the displacement of the indicator relative to the plumb line on the ruler scale.

In a preferred embodiment, the method comprising using computer vision to perform the analysing.

In a preferred embodiment, the method comprising using computer vision to automatically identify if the straightness of the guide rail is feasible or unfeasible.

In a preferred embodiment, the method comprising using computer vision to identify values of the displacement of the indicator relative to the plumb line, and storing the values in the memory.

In a preferred embodiment, the method comprising moving the elevator car in the shaft at a predetermined auditing speed.

In a preferred embodiment, the method comprising synchronizing the values of relative displacement in first horizontal direction and in second horizontal direction with the predetermined auditing speed to match the recorded values with respective vertical positions, preferably forming a matrix containing relative displacement in the first horizontal direction, relative displacement in the second horizontal direction, and respective vertical position.

In a preferred embodiment, the method comprising storing the matrix containing relative displacement in the first direction, relative displacement in the second direction, and respective vertical position to the memory to be used in diagnostics over the life cycle of the elevator.

In a preferred embodiment, the method comprising locking suspension of a guide member connected to the car guide rail to be audited.

In a preferred embodiment, the method comprising after the auditing steps, performing correcting measures to the car guide rails audited, and optionally repeating the auditing steps.

The invention separates the preparation step and the auditing step into two separate steps that may be carried out independently of each other at different times. Thus, the auditing steps may be repeated during installation and maintenance without having to repeat preparation steps to audit the of the aligning.

The invention makes it possible to carry out auditing efficiently, but without requiring high-end expensive equipment. Further, the recorded auditing results may be utilized as reference and support in adjusting the car guide rails to facilitate alignment of the guide rails.

The invention may be used in manual and in automated car guide rail straightness auditing.

### BRIEF DESCRIPTION OF DRAWINGS

The invention will in the following be described in greater detail by means of preferred embodiments with reference to the attached drawings, in which

FIG. 1 illustrates a side view of an elevator,

FIG. 2 illustrates a magnified view of FIG. 1,

FIG. 3 illustrates a horizontal cross section of an elevator,

FIG. 4 illustrates a horizontal cross section of an elevator comprising an embodiment of the invention,

FIG. 5 illustrates an embodiment of the invention from direction Y, wherein the visual recording device is not shown,

FIG. 6 illustrates an embodiment of the invention from direction Y,

FIG. 7 illustrates the embodiment of FIG. 6 from direction X, and

FIG. 8 illustrates an embodiment of a method according to the invention.

### DETAILED DESCRIPTION OF AT LEAST ONE EMBODIMENT

In the present figures, the elevator, and the arrangement 1 are not shown to scale, but the figures are schematic, illustrating the basic structure and operation of the preferred embodiments. In this case, the components indicated by reference numerals in the accompanying figures correspond to the components indicated by reference numerals in this specification.

In the accompanying figures and the description below, the term vertical direction Z refers to a vertical direction in an elevator shaft 20. Further, the term first horizontal direction X refers to a direction between the guide rails (DBG) and a second horizontal direction Y refers to a direction from the back wall to the front wall (BTF) in the shaft 20. The first horizontal direction X is perpendicular to the second horizontal direction Y. The first horizontal direction X and the second horizontal direction Y are perpendicular to the vertical direction Z.

The elevator may comprise a car 30, an elevator shaft 20, hoisting machinery 60, suspension ropes 42, and a counterweight 41. A separate or an integrated car frame 31 may surround the car 30.

The hoisting machinery 60 may be positioned in the shaft 20. The hoisting machinery may comprise a drive 61, an electric motor 62, a traction sheave 63, and a machinery brake 64. The hoisting machinery 60 may move the car 30 in a vertical direction Z upwards and downwards in the vertically extending elevator shaft 20. The machinery brake 64 may stop the rotation of the traction sheave 63 and thereby the movement of the elevator car 30.

The car frame 31 may be connected by the ropes 42 via the traction sheave 63 to the counterweight 41. The car frame 31 is further connected with guide members 11 to guide rails 10 extending in the vertical direction Z in the shaft 20. The guide members 11 may comprise rollers rolling on the car guide rails 10 or gliding shoes gliding on the car guide rails 10 when the car 30 is moving upwards and downwards in the elevator shaft 20. The guide members 11 may each comprise a suspension for increasing ride comfort of the elevator. In a straightness auditing mode, the suspension of the guide member 11 connected to the car guide rail 10 to be audited may be locked. Further, in the straightness auditing mode the suspension of the guide member 11 not connected to the car guide rail 10 to be audited may be adapted to press the guide member 11 connected to the car guide rail 10 to be audited against the car guide rail 10, so that the elevator car 30 follows the car guide rail 10 to be audited. The guide rails 10 may be attached with fastening brackets 50 to side wall structures 21 in the elevator shaft 20. The guide members 11 keep the car 10 in position in the horizontal plane when the car 30 moves upwards and downwards in the elevator shaft 20. The counterweight 41 may be supported in a corresponding way on counterweight guide rails that are attached to the wall structure 21 of the shaft 20.

The wall structure 21 of the shaft 20 may be formed of solid walls 21 or of open beam structure or of any combination of these. One or more of the walls may thus be solid and one or more of the walls may be formed of an open beam structure. There may be two guide rails 10 for the car 30. The two car guide rails 10 may be positioned on opposite side walls of the shaft 20. There may further be two guide rails for the counterweight 41.

The car guide rails 10 may extend vertically along the height of the elevator shaft 20. The car guide rails 10 may thus be formed of guide rail elements of a certain length e.g. 5 m. The guide rail elements may be installed end-on-end one after the other. The guide rail elements may be attached to each other with connection plates extending between the end portions of two consecutive guide rail elements. The connection plates may be attached to the consecutive guide rail elements. The ends of the guide rails may comprise form locking means to position the guide rails correctly in relation to each other. The guide rails may be attached to the walls 21 of the elevator shaft 20 with support elements at support points along the height of the guide rails.

The car 30 may transport people and/or goods between the landings in the building.

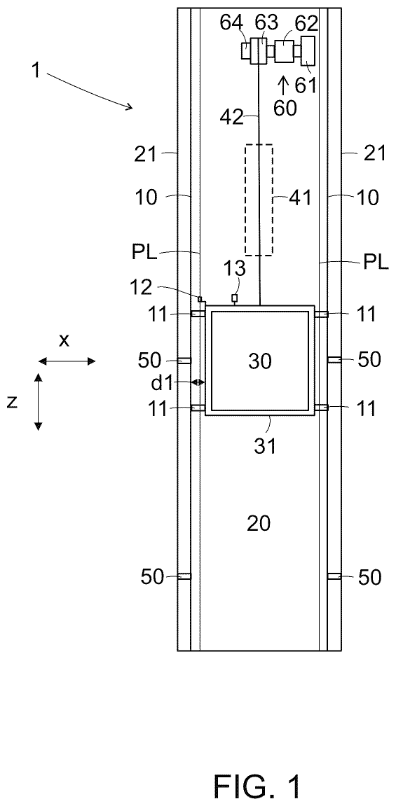

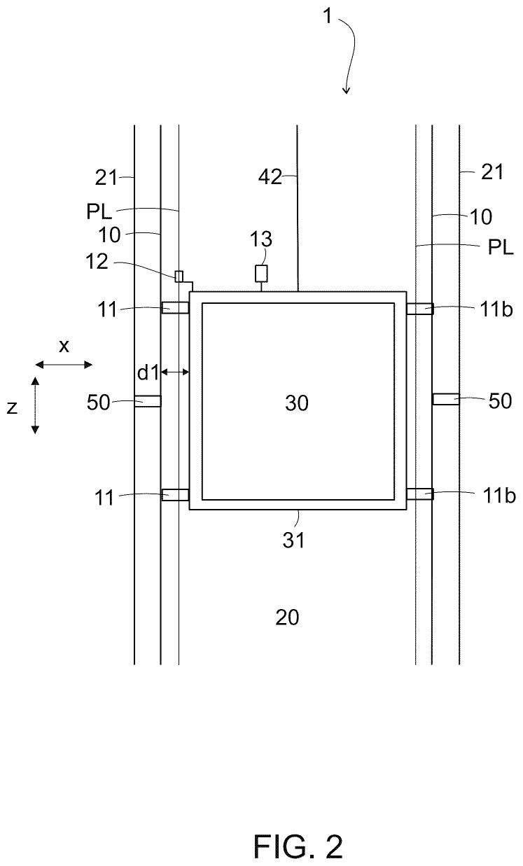

FIGS. 1 and 2 illustrate a side view of an elevator comprising an arrangement 1 for auditing straightness of a car guide rail 10.

The arrangement 1 comprises a car guide rail 10 mounted in an elevator shaft 20, and an elevator car 30 connected to the car guide rail 10 via a guide member 11. Said guide member 11, in a straightness auditing mode being adapted so that the horizontal distance d1 between the elevator car 30 and the car guide rail 10 to be audited is constant. This straightness auditing mode allows the straightness of the car guide rail 10 to be indirectly audited with elements connected to the elevator car 30, thus providing more design options for the arrangement 1.

The arrangement 1 further comprises a plumb line PL stabilized in the elevator shaft 20 adjacent to the car guide rail 10. Using a plumb line PL is a cost-effective way to obtain a reference line, which is vertical. The plumb line is preferably formed of plumb wire but may alternatively be formed of a visual laser beam set vertical in the elevator shaft.

The arrangement 1 further comprises an indicator 12 detachably attached to the elevator car 30, in vicinity of the plumb line PL. In this connection in vicinity refers to a distance between 0 to 50 mm, more preferably 0 to 10 mm, most preferably 2 mm. Attaching the indicator 12 in vicinity of the plumb line PL facilitates observing the relative positions of the indicator 12 and the plumb line PL.

The arrangement 1 further comprises at least one visual recording device 13 detachably attached to the elevator car 30, facing the plumb line PL and the indicator 12, for recording a displacement x1, y1 of the indicator relative to the plumb line. The visual recording device 13 allows the relative positions of the indicator 12 and the plumb line PL to be recorded, and thus the straightness of the car guide rail to be audited.

The arrangement 1 further comprises a memory for storing recorded relative displacement x1, y1. This allows the recording to be analysed and be stored for later use. Preferably the memory is a local memory at the site and/or a remote memory outside the site, particularly a cloud memory. The measurement results may be transmitted by wireless communication and/or by cable to the memory.

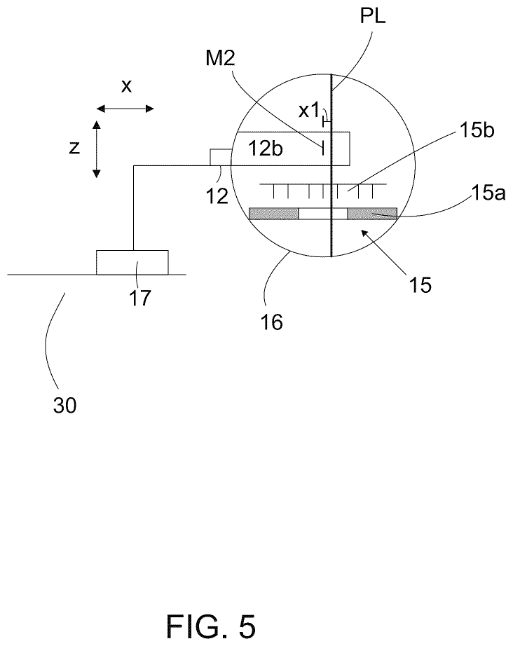

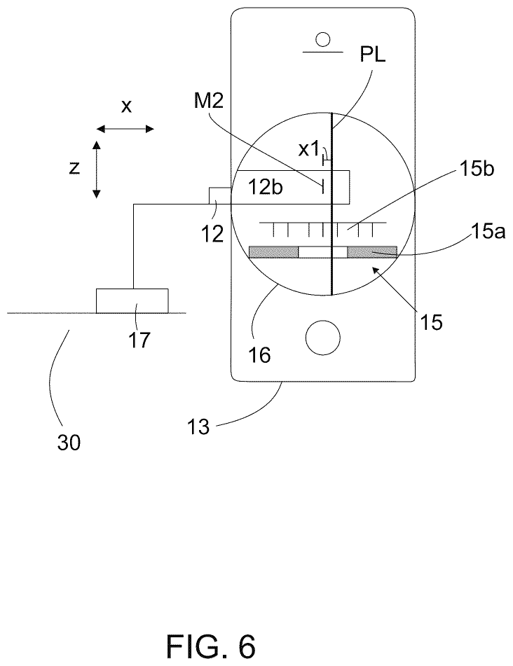

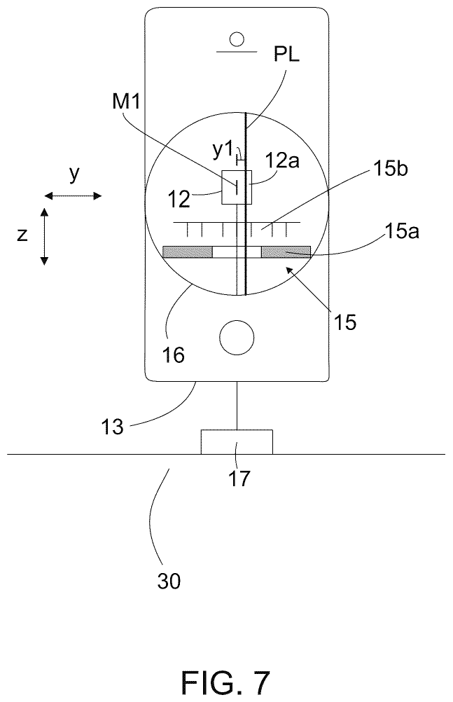

As illustrated in FIGS. 5 to 7, the arrangement 1 preferably comprises a ruler scale 15 comprising simple visual markings 15a illustrating if the displacement x1, y1 of the indicator 12 relative to the plumb line PL is feasible or unfeasible. This allows the technician performing the auditing to easily determine if the straightness of the car guide rail 10 is feasible or not. Ranges of the feasibility scale may be predetermined for certain elevator types and/or applications to expedite the auditing process. Alternatively, the range of the feasibility scale can be individually adjusted for each use.

As illustrated in FIGS. 5 to 7, the arrangement preferably comprises more detailed visual markings 15b configured to provide numerical values for said relative displacement x1, y1. This allows numerical values for the relative displacement x1, y1 to be recorded and thus more detailed data of the auditing to be recorded. The detailed visual markings 15b may be formed of parallel lines having set internal distances of 0.1 mm to 5 mm. These numerical values and more detailed data may be later used in diagnostics or maintenance operations, for instance.

Preferably, the ruler scale 15 comprising the simple visual markings 15a and/or the detailed visual markings 15b is either virtual or physical. The physical embodiment of the ruler scale 15 can be implemented in background of the plumb line PL and the indicator 12 viewed from the visual recording device 13, or the ruler scale 15 may arranged in the indicator 12, for instance. The indicator 12 may comprise see-through material and comprise the ruler scale 15, thus simplifying the construction of the arrangement 1. However, also other configurations of the ruler scale 15 may be used. The virtual embodiment of the ruler scale 15 may be implemented in a software used for viewing the recording, for instance.

As illustrated in FIGS. 5 to 7, the arrangement 1 preferably comprises a magnifier 16 configured to magnify the displacement x1, y1 of the indicator 12 relative to the plumb line PL, preferably on the ruler scale 15. As the lighting conditions in the elevator shaft 20 are not often optimal, the magnifier 16 facilitates interpretation of the ruler scale 15. The magnifier 16 also allows more relevant details of the ruler scale 15, the indicator 12, and the plumb line PL to be captured with the visual recording device 13, thus increasing accuracy of the auditing.

The magnifier 16 may be either virtual or physical. A simple physical implementation is to arrange a magnifying glass in between the visual recording device 13, and the indicator 12 and the plumb line PL. The virtual embodiment of the magnifier 16 may also be implemented with a software. However, also other suitable magnifying constructions may be used.

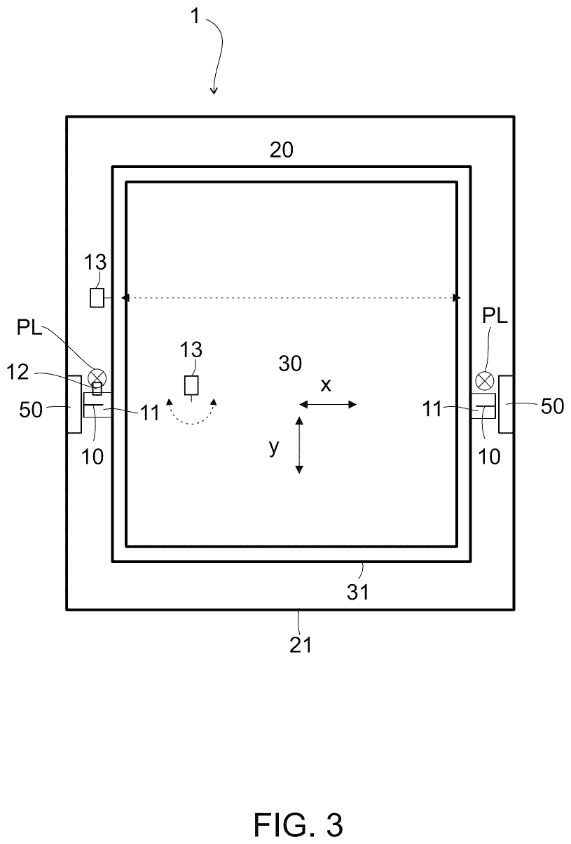

Preferably, as illustrated in FIG. 3, the visual recording device 13 is configured to face the plumb line PL and the indicator 12 in a first horizontal direction X between the car guide rails 10, or in a second horizontal direction Y perpendicular to said first horizontal direction X between the car guide rails 10. This is preferable as the fastening brackets 50 of the car guide rails 10 are often adjustable in said directions X, Y. Therefore, readings in these directions X, Y may be used to map the relative position of the car guide rail 10 on a horizontal plane formed by the first horizontal direction X and the second horizontal direction Y, and these relative positions may be used as a guide for adjusting the fastening brackets 50 of the car guide rails 10.

Preferably, as illustrated in FIG. 3, the arrangement 1 comprises two visual recording devices 13 facing the indicator 12 and the plumb line PL substantially perpendicular in relation to each other, preferably in a first horizontal direction X between the car guide rails 10, and in a second horizontal direction Y perpendicular to said first horizontal direction Z between the car guide rails 10. This is beneficial as use of such positioned visual recording devices 13 allows both relative horizontal displacements x1, y1 to be captured simultaneously, thus reducing the time used for the auditing.

Preferably, as illustrated in FIG. 3, one visual recording device 13 is configured to be rotatable at least on a horizontal plane XY defined by the first horizontal direction X and the second horizontal direction Y. Further, preferably the other visual recording device 13 is configured to be movable at least in the first horizontal direction X between the car guide rails 10. This allows both car guide rails 10 to be easily audited without detaching and reattaching the visual recording devices 13. In this case the arrangement comprises servomotors or servocontrolled mechanisms for actuating the rotation and the movement of the visual recording devices 13. However, also other configurations could be used for actuating the rotation and the movement of the visual recording devices. Using such a configuration is advantageous as the visual recording devices 13 may be left in the elevator shaft 20 to monitor the elevator shaft 20 during the lifetime of the elevator and be used for remote troubleshooting of the elevator.

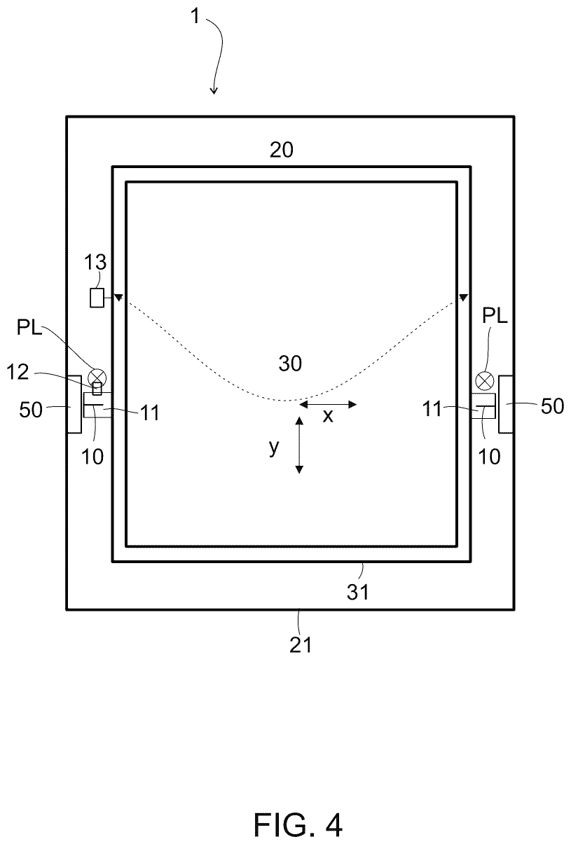

FIG. 4 illustrates an embodiment of the invention, wherein the arrangement 1 comprises a visual recording device 13 configured to be rotatable and movable in the horizontal plane defined by the first horizontal direction and the second horizontal direction. This allows one visual recording device 13 to be used for recording both in first horizontal direction X and in second horizontal direction Y without detaching and reattaching the visual recording device 13.

Preferably, the visual recording device 13 is also rotatable on a vertical plane perpendicular to the horizontal plane defined by the first horizontal direction X and the second horizontal direction Y.

Preferably, the visual recording device 13 is configured to be rotatable on the horizontal plane and/or on the vertical plane at least 180 degrees, preferably 360 degrees. This allows the visual recording device 13 to face any desired direction in the elevator shaft 20.

Preferably, as illustrated in FIGS. 5 to 7, the indicator 12 comprises at least one reference marker M1, M2, preferably two reference markers M1, M2, such that a first surface 12a of the indicator 12 facing the first horizontal direction X between the car guide rails, and a second surface 12b of the indicator 12 facing the second horizontal direction Y perpendicular to said first horizontal direction X between the car guide rails 10 each comprise a reference marker M1, M2. These reference markers facilitate visual comparison of the relative positions of the indicator 12 and the plumb line PL, preferably on the ruler scale 15. Having a reference marker M1, M2 in each said surface 12a, 12b allows the indicator 12 and the plumb line PL to be recorded in both directions simultaneously, or alternatively the indicator 12 not to be moved if the auditing is performed one direction at a time. Alternatively, the reference marker M1, M2 may be located inside the indicator, if the indicator comprises see-through material. The reference markers M1, M2 may be formed as parallel lines having a set internal distance, 0.1 mm to 5 mm for instance, thus forming a kind of a ruler.

Preferably, the indicator 12 and/or the visual recording device 13 and/or the ruler scale 15 is detachably attached to the elevator car 30 via a fastening element 17, preferably comprising a magnet as illustrated in FIGS. 5 to 7, or a clamp. Using a magnet or a clamp for the detachable attaching is advantageous, as these do not damage the elevator or require holes to be made in the elevator. However, also other suitable fastening elements, preferably non-intrusive fastening elements may be used.

Preferably, the visual recording device 13 is a camera or a device comprising a camera, and preferably the device comprising the camera is a mobile phone. This is advantageous as the mobile phone may also be used to analyse the recording on site, thus reducing the amount of special equipment needed. Additionally, technicians often already have suitable mobile phones, which may be used as the visual recording device 13, thus further reducing need for special equipment.

Preferably, the plumb line PL is fixed at the top of the elevator shaft 20. This allows the weight of the plumb to straighten the plumb line, thus creating a vertical line. After the vertical line of the plumb line PL has been stabilized, the plumb line is preferably further fixed to the bottom of the elevator shaft 20. This is advantageous as this locks the vertical alignment of the plumb line PL, and mitigates environmental factors such as wind or physical touch from altering the alignment of the plumb line PL.

Preferably, the indicator 12 and the visual recording device 13 are detachably attached to a dust plate of the guide member 11. However, any convenient location on the elevator car or parts connected to it may be used.

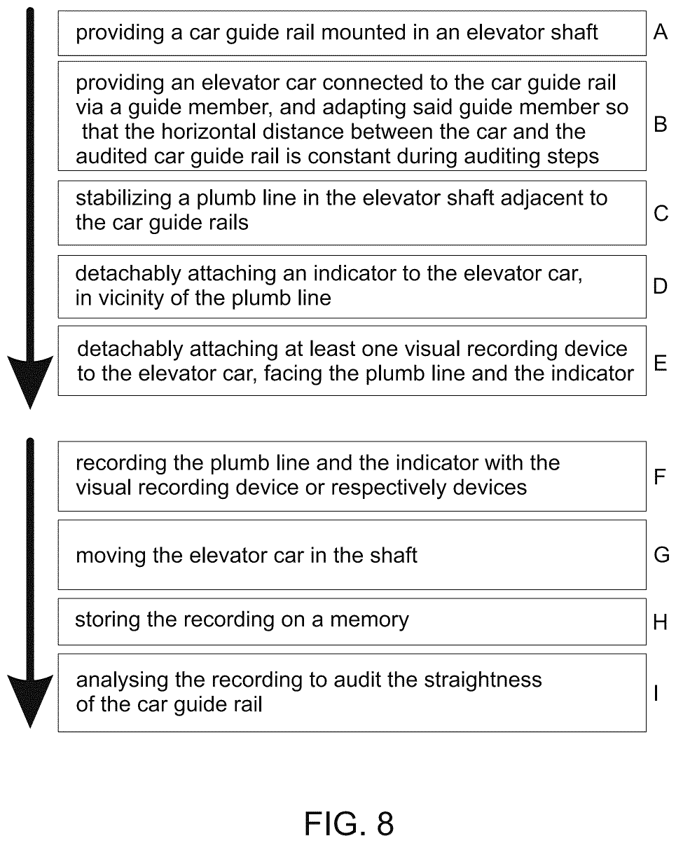

FIG. 8 illustrates a method for auditing straightness of a car guide rail. The method of FIG. 8 comprising preparation steps (A) to (E), and auditing steps (F) to (I). The preparation steps (A) to (E), and auditing steps (F) to (I) may be performed separately. The method steps (A) to (I) are described in more detail below.

(A) providing a car guide rail mounted in an elevator shaft.

(B) providing an elevator car connected to the car guide rail via a guide member and adapting said guide member so that the horizontal distance between the car and the audited car guide rail is constant during auditing steps. This allows straightness auditing tools such as an indicator, a recording device, a magnifier, or a ruler scale to be attached to the car or any part connected to the car as the car follows the car guide rail. Thus, increasing the number of options for positioning of said auditing tools.

(C) stabilizing a plumb line in the elevator shaft adjacent to the car guide rail. The plumb line is preferably formed of plumb wire but may alternatively be formed of a visual laser beam set vertical in the elevator shaft. Use of such plumb line is advantageous, as it is often already present in the elevator shaft. Thus, often no additional work is required for stabilizing the plumb line in the elevator shaft.

(D) detachably attaching an indicator to the elevator car, in vicinity of the plumb line. This allows the relative position of the indicator and the plumb line to be easily observed. In this connection in vicinity refers to a distance between 0 to 50 mm, more preferably 0 to 10 mm, most preferably 2 mm.

(E) detachably attaching at least one visual recording device to the elevator car, facing the plumb line and the indicator. This visual recording device allows the indicator and the plumb line to be recorded during auditing.

(F) recording the plumb line and the indicator with the visual recording device or respectively devices. This allows displacement of the indicator relative to the plumb line to be recorded. Preferably, this recording is conducted as a continuous recording, or as taking pictures at predetermined times. Both implementations allow the straightness of the car guide rail to be analysed. However, also other suitable visual recording methods could be used.

(G) moving the elevator car in the shaft. This allows the straightness of the car guide rail to be audited at different vertical positions. Preferably the movement is an upwards movement started from the bottom floor of the elevator and continued until top floor of the elevator is reached. Further, it is advantageous to conduct the movement of the elevator car at a predetermined auditing speed. This allows the recording to be matched with the vertical position when auditing speed and auditing time are known.

(H) storing the recording on a memory. This allows the recording to be analysed and be stored for later use. Preferably the memory is a local memory at the site and/or a remote memory outside the site, particularly a cloud memory. The measurement results may be transmitted by wireless communication and/or by cable to the memory.

(I) analysing the recording to audit the straightness of the car guide rail. Preferably the analysing of the recording is done by using computer vision, but the analysing may also be done manually by the technician performing the auditing.

Preferably, the method illustrated in FIG. 8 further comprising after completion of the auditing steps, repositioning the visual recording device such that the visual recording device faces the plumb line and the indicator in a direction perpendicular relative to its initial position, and then repeating the auditing steps.

Preferably, the method illustrated in FIG. 8 further comprising arranging the visual recording device to face the plumb line and the indicator in a first horizontal direction between the car guide rails, or in a second horizontal direction perpendicular to said first horizontal direction between the car guide rails.

Preferably, the method illustrated in FIG. 8 further comprises arranging two visual recording devices facing the plumb line and the indicator, the two visual recording devices positioned perpendicular in relation to each other, preferably in a first horizontal direction between the car guide rails, and in a second horizontal direction perpendicular to said first horizontal direction between the car guide rails.

Preferably, the method illustrated in FIG. 8 further comprises providing a ruler scale in background of the plumb line and the indicator viewed from the visual recording device, or providing the ruler scale in the indicator.

Preferably, the method illustrated in FIG. 8 further comprises providing a magnifier to magnify the displacement of the indicator relative to the plumb line on the ruler scale.

Preferably, the method illustrated in FIG. 8 further comprises using computer vision to automatically identify if the straightness of the guide rail is feasible or unfeasible. This reduces humane errors and decreases the factor of technician's experience in interpreting the recording. Further, the computer vision may be used to identify values of the displacement of the indicator relative to the plumb line and storing the values in the memory. This reduces manual work, and thus makes it easier to collect and store more detailed data from the auditing process. Preferably, further the method comprises synchronizing the values of relative displacement in first horizontal direction and in second horizontal direction with the predetermined auditing speed to match the recorded values with respective vertical positions, preferably forming a matrix containing relative displacement in the first horizontal direction, relative displacement in the second horizontal direction, and respective vertical position. This allows a clean data set to be collected in the auditing process.

Said matrix containing relative displacement in the first horizontal direction, relative displacement in the second horizontal direction, and respective vertical position may be stored to the memory to be used in diagnostics over the life cycle of the elevator. This facilitates quality control, product development, and customer satisfaction.

Preferably, the method illustrated in FIG. 8 further comprises in step (B) locking suspension of the guide member connected to the car guide rail to be audited. This allows the car to follow the car guide rail. However, not all guide members comprise suspension, and in such cases alternative methods for controlling the horizontal distance between the car and the guide rail to be audited may be used.

Preferably, the method illustrated in FIG. 8 further comprises after the auditing steps, performing correcting measures to the car guide rails audited, and optionally repeating the auditing steps.

The shaft 20 in the FIGS. 1 to 4 is intended for only one car 30, but the invention could naturally be used in shafts intended for several cars 30. Such elevator shafts 20 could be divided into sub-shafts for each car 30 with steel bars. Horizontal steel bars could be provided at predetermined intervals along the height of the shaft 20. A part of the guide rails 10 would then be attached to the steel bars in the shaft 20. Another part of the guide rails 10 would be attached to solid walls 21 in the shaft 20.

The arrangement according to the invention is better suited for low-rise and mid-rise buildings, in which the height of the elevator shaft, and the elevator travel speed are not as high as in high-rise buildings. Therefore, the straightness of the car guide rails, and respectively accuracy of the car guide rail auditing does not need to be as high as in high-rise buildings. However, the use of the invention is not limited to the elevator disclosed in the figures. The invention can be used in any type of elevator e.g. an elevator comprising a machine room or lacking a machine room, an elevator comprising a counterweight or lacking a counterweight. The counterweight could be positioned on either side wall or on both side walls or on the back wall of the elevator shaft. The drive, the motor, the traction sheave, and the machine brake could be positioned in a machine room or somewhere in the elevator shaft. The elevator car guide rails could be positioned on opposite side walls of the shaft or on a back wall of the shaft in a so called ruck-sack elevator.

It is to be understood that the above description and the accompanying figures are only intended to teach the best way known to the inventors to make and use the invention. It will be apparent to a person skilled in the art that the inventive concept can be implemented in various ways. It is therefore to be understood that the invention and its embodiments are not limited to the examples described above but may vary within the scope of the claims.

1. An arrangement for auditing straightness of a car guide rail the arrangement comprising:
a car guide rail mounted in an elevator shaft,
an elevator car connected to the car guide rail via a guide member, said guide member, in a straightness auditing mode being adapted so that the horizontal distance between the elevator car and the car guide rail to be audited is constant,
a plumb line stabilized in the elevator shaft adjacent to the car guide rail,
an indicator detachably attached to the elevator car, in vicinity of the plumb line,
at least one visual recording device, wherein the visual recording device is a camera or a device comprising a camera, detachably attached to the elevator car, facing the plumb line and the indicator, for recording a displacement of the indicator relative to the plumb line,
a memory for storing recorded relative displacement, and
wherein the recording is a continuous recording, or pictures taken at predetermined times.

2. The arrangement according to claim 1, wherein the arrangement comprises a ruler scale comprising simple visual markings illustrating if the displacement of the indicator relative to the plumb line is feasible or unfeasible, and/or more detailed visual markings configured to provide numerical values for said relative displacement.

3. The arrangement according to claim 2, wherein the ruler scale is arranged in background of the plumb line and the indicator viewed from the visual recording device, or the ruler scale is arranged in the indicator.

4. The arrangement according to claim 1, wherein the arrangement comprises two visual recording devices facing the indicator and the plumb line substantially perpendicular in relation to each other, preferably in a first horizontal direction between the car guide rails, and in a second horizontal direction perpendicular to said first horizontal direction between the car guide rails.

5. The arrangement according to claim 1, wherein the indicator comprises at least one reference marker, preferably two reference markers, such that a first surface of the indicator facing a first horizontal direction between the car guide rails, and a second surface of the indicator facing a second horizontal direction perpendicular to said first horizontal direction between the car guide rails each comprise a reference marker.

6. The arrangement according to claim 1, wherein the indicator and/or the visual recording device and/or the ruler scale is detachably attached to the elevator car via a fastening element, preferably comprising a magnet or a clamp.

7. A method for auditing straightness of a car guide rail, the method comprising preparation steps:
(A) providing a car guide rail mounted in an elevator shaft,
(B) providing an elevator car connected to the car guide rail via a guide member, and adapting said guide member so that the horizontal distance between the car and the audited car guide rail is constant during auditing steps,
(C) stabilizing a plumb line in the elevator shaft adjacent to the car guide rail,
(D) detachably attaching an indicator to the elevator car, in vicinity of the plumb line,
(E) detachably attaching at least one visual recording device, wherein the visual recording device is a camera or a device comprising a camera, to the elevator car, facing the plumb line and the indicator,
and the method comprising auditing steps:
(F) recording the plumb line and the indicator with the visual recording device or respectively devices as a continuous recording or as pictures taken at predetermined times,
(G) moving the elevator car in the shaft,
(H) storing the recording on a memory, and
(I) analysing the recording to audit the straightness of the car guide rail.

8. The method according to claim 7, comprising arranging the visual recording device to face the plumb line and the indicator in a first horizontal direction between the car guide rails, or in a second horizontal direction perpendicular to said first horizontal direction between the car guide rails.

9. The method according to claim 7, comprising after completion of the auditing steps, repositioning the visual recording device such that the visual recording device faces the plumb line and the indicator in a direction perpendicular relative to its initial position, and then repeating the auditing steps.

10. The method according to claim 7, comprising arranging two visual recording devices facing the plumb line and the indicator, the two visual recording devices positioned perpendicular in relation to each other, preferably in a first horizontal direction between the car guide rail, and in a second horizontal direction perpendicular to said first horizontal direction between the car guide rails.

11. The method according to claim 7, comprising providing a ruler scale in background of the plumb line and the indicator viewed from the visual recording device, or providing the ruler scale in the indicator.

12. The method according to claim 7, comprising using computer vision to perform the analysing.

13. The method according to claim 12, comprising using computer vision to automatically identify if the straightness of the guide rail is feasible or unfeasible.

14. The method according to claim 12, comprising using computer vision to identify values of the displacement of the indicator relative to the plumb line, and storing the values in the memory.

15. The method according to claim 7, comprising locking suspension of a guide member connected to the car guide rail to be audited.
